(19) United States
(12) Patent Application Publication
(10) Pub. No.: US 2026/0302897 A1
(43) Pub. Date: Oct. 1, 2026

(54) LINEAR MOTOR MODULE AND LINEAR CONVEYANCE SYSTEM

(71) Applicant: THK CO., LTD., Tokyo (JP)

(72) Inventors: Akihiro UNNO, Tokyo (JP); Shigeki HAYASHI, Kawasaki-shi (JP)

(73) Assignee: THK CO., LTD., Tokyo (JP)

(21) Appl. No.: 19/489,924

(22) PCT Filed: May 28, 2024
(86) PCT No.: PCT/JP2024/019534

§ 371 Date: Dec. 4, 2025

(30) Foreign Application Priority Data
Jun. 9, 2023 (JP) 2023-095688

(51) Int. Cl. H02K 11/33; B65G 54/02; H02K 41/03

(52) U.S. Cl. CPC H02K 11/33; B65G 54/02; H02K 41/031; H02K 2211/03

(57) ABSTRACT

The present invention provides a linear motor module (3) including a drive board (50) and a base member (20). A seat portion (22) is provided in the base member (20). A plurality of space portions (24) are formed in a side portion of the seat portion (22) with an interval therebetween in a length direction. A plurality of protruding portions (52) inserted into the plurality of space portions (24) are formed in the drive board (50).

### TECHNICAL FIELD

The present invention relates to a linear motor module and a linear conveyance system. Priority is claimed on Japanese Patent Application No. 2023-095688, filed Jun. 9, 2023, the content of which is incorporated herein by reference.

### BACKGROUND ART

Patent Document 1 discloses a linear conveyance device in which a linear motor is constituted by connecting a plurality of stator units. Each of the stator units includes a stator fixed to a unit frame, and a sensor board for controlling a flow of current to the stator.

### CITATION LIST

### Patent Document

Patent Document 1: Japanese Unexamined Patent Application, First Publication No. 2013-176214

### SUMMARY OF INVENTION

### Technical Problem

In the linear motor module described above, a small footprint and a small height dimension are required for the purpose of miniaturizing the module and securing a surrounding working space. In the stator units of Patent Document 1, as shown in FIG. 3, the sensor board is vertically fixed to a side surface of the unit frame, which can reduce the footprint but increases the height dimension.

The present invention has been made in consideration of the foregoing circumstances, and an object thereof is to provide a linear motor module and a linear conveyance system having a small footprint and a small height dimension.

### Solution to Problem

According to a first aspect of the present invention, a linear motor module includes a track body guiding a mobile body, a plurality of coil units disposed along the track body, a drive board electrically connected to the plurality of coil units, and a base member supporting the track body, the plurality of coil units, and the drive board. A seat portion for supporting the track body is provided in the base member. A plurality of space portions are formed in a side portion of the seat portion with an interval therebetween in a length direction in which the track body extends. A plurality of protruding portions inserted into the plurality of space portions are formed in the drive board.

According to a second aspect of the present invention, in the linear motor module according to the first aspect, a motor driver for controlling the coil unit is provided in the protruding portion.

According to a third aspect of the present invention, in the linear motor module according to the second aspect, a bottom plate portion for supporting the seat portion is provided in the base member. The motor driver is disposed on a surface of the protruding portion facing the bottom plate portion and is in contact with the bottom plate portion via a heat transfer member.

According to a fourth aspect of the present invention, in the linear motor module according to the second aspect or the third aspect, the plurality of space portions include a first space portion formed to have a first length in the length direction, and a second space portion formed to have a second length longer than the first length in the length direction. The plurality of protruding portions include a first protruding portion inserted into the first space portion, and a second protruding portion inserted into the second space portion and having a larger width than the first protruding portion in the length direction. The second protruding portion is provided with a greater number of the motor drivers than the first protruding portion and is provided with at least a part of a control chip for controlling the motor drivers.

According to a fifth aspect of the present invention, a linear conveyance system includes the linear motor module according to any one of the first aspect to the third aspect, and a mobile body including a magnet capable of facing the plurality of coil units and guided along the track body. A plurality of the linear motor modules are joinable such that a plurality of the track bodies are connected in series.

### Advantageous Effects of Invention

According to an aspect of the present invention, it is possible to reduce a footprint and reduce a height dimension.

### BRIEF DESCRIPTION OF DRAWINGS

FIG. 1 An overall view of a linear conveyance system according to an embodiment.

FIG. 2 A perspective view of a mobile body and a linear motor module according to the embodiment.

FIG. 3 A view of the mobile body and the linear motor module according to the embodiment in an X axis direction.

FIG. 4 A perspective view of the linear motor module according to the embodiment.

FIG. 5 A perspective view of a base member and a drive board according to the embodiment.

FIG. 6 A plan view of the base member and the drive board shown in FIG. 5.

FIG. 7 A perspective view showing an assembly state of the base member and the drive board according to the embodiment.

### DESCRIPTION OF EMBODIMENT

Hereinafter, an embodiment of the present invention will be described with reference to the drawings.

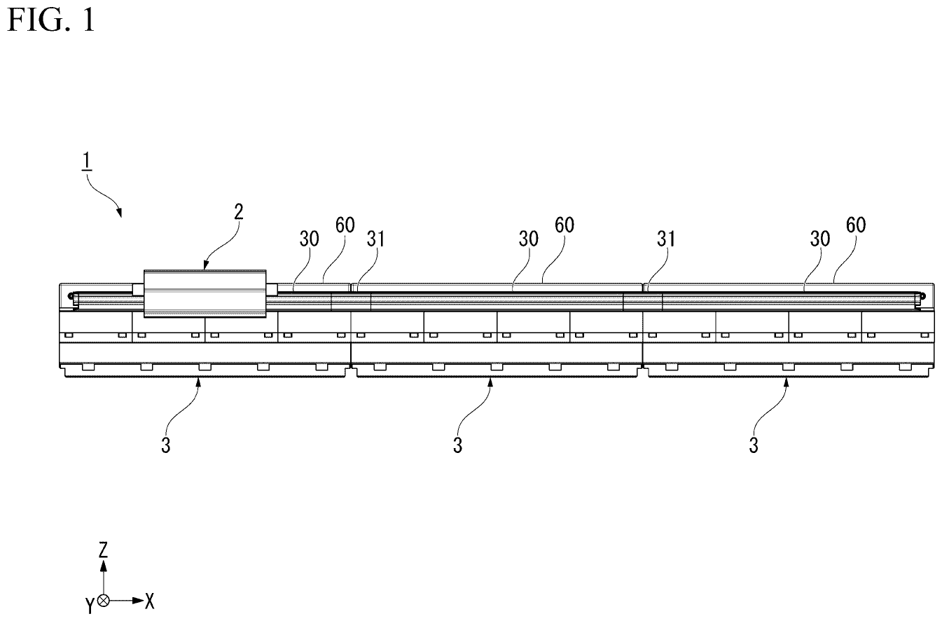

FIG. 1 is an overall view of a linear conveyance system 1 according to the embodiment.

As shown in FIG. 1, the linear conveyance system 1 includes a mobile body 2 and a linear motor module 3. The mobile body 2 is also referred to as a movable unit. In addition, the linear motor module 3 is also referred to as a stator unit. The linear motor module 3 includes a track body 30 guiding the mobile body 2, and a linear encoder 60 disposed along the track body 30.

A plurality of linear motor modules 3 are joinable such that a plurality of track bodies 30 are connected in series. In the example of FIG. 1, three linear motor modules 3 are joined. A joint rail 31 is arranged between a track body 30 of the linear motor module 3 and a track body 30 of an adjacent linear motor module 3. The mobile body 2 can move along adjacent track bodies 30 joined as a single line by the joint rails 31.

In the following description, an XYZ orthogonal coordinate system is set, and the positional relationship of each member may be described with reference to this XYZ orthogonal coordinate system. An X axis direction is a length direction in which the track body 30 extends (moving direction of the mobile body 2). A Y axis direction is a width direction of the track body 30 orthogonal to the X axis direction. A Z axis direction is a height direction of the track body 30 orthogonal to the X axis direction and the Y axis direction.

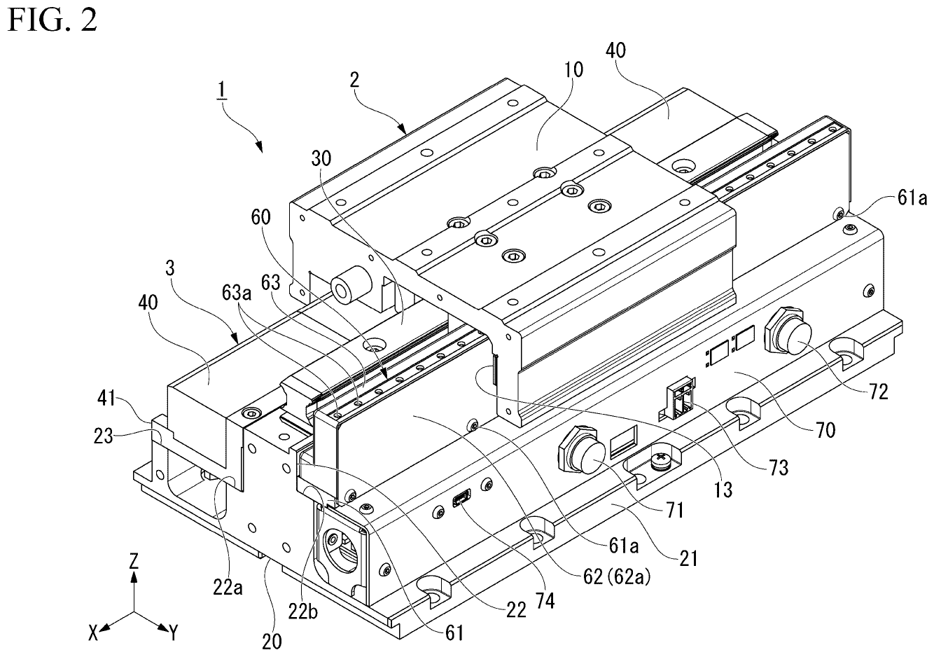

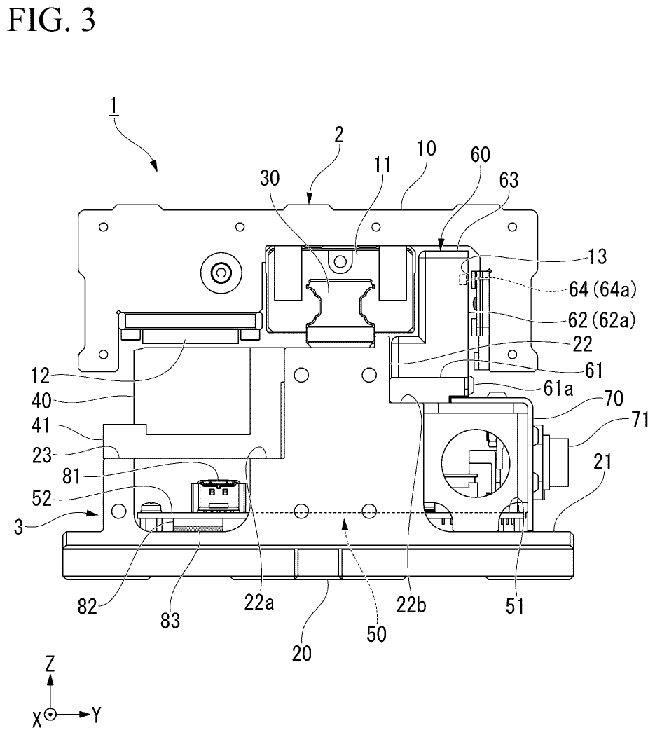

FIG. 2 is a perspective view of the mobile body 2 and the linear motor module 3 according to the embodiment. FIG. 3 is a view of the mobile body 2 and the linear motor module 3 according to the embodiment in the X axis direction.

As shown in FIG. 3, the mobile body 2 includes a table 10, a slider block 11, a magnet 12, and a linear scale 13.

The table 10 includes a top plate portion extending along an X-Y plane, and a pair of side wall portions hanging downward from both end portions of the top plate portion in the Y axis direction. A conveyance object (not shown) can be fixed on the upper surface side of the top plate portion of the table 10.

The slider block 11 is mounted on the lower surface side of the top plate portion of the table 10. The slider block 11 engages with the track body 30 in a manner of being movable in the X axis direction. Recessed portions are formed on side surfaces of the track body 30 on both sides in the Y axis direction, and the slider block 11 includes projection portions which engage with the recessed portions.

A rolling element transfer path for endlessly transferring a rolling element (not shown) may be formed between the recessed portions of the track body 30 and the projection portions of the slider block 11. For example, the rolling element transfer path may be provided in two rows in total, one row each on both sides of the track body 30 in the Y axis direction, or may be provided in four rows in total, two rows each on both sides of the track body 30 in the Y axis direction.

In addition, the magnet 12 is mounted on the lower surface side of the top plate portion of the table 10. The magnet 12 is disposed on the negative Y side of the slider block 11. The magnetic poles of the magnet 12 are directed downward. The downward magnetic poles of the magnet 12 are arranged such that the N poles and the S poles are alternately aligned in the X axis direction.

The linear scale 13 is mounted on an inner wall surface of the side wall portion of the table 10 on the positive Y side. The linear scale 13 is formed to have a thin plate-rod shape extending in the X axis direction. The linear scale 13 faces detection portions 64a of the linear encoder 60 in the Y axis direction. The linear scale 13 and the linear encoder 60 may be an optical type or a magnetic type.

The linear motor module 3 includes a base member 20, the track body 30, coil units 40, a drive board 50, the linear encoder 60, and a cover 70. For example, the base member 20 is preferably a light-weight metal member such as aluminum having heat dissipation properties and includes a bottom plate portion 21, a seat portion 22, and a column portion 23. The bottom plate portion 21 is formed to have a plate shape extending along the X-Y plane.

The seat portion 22 stands upward (positive Z side) from a central portion of the bottom plate portion 21 in the Y axis direction. The track body 30 described above is mounted on the top portion of the seat portion 22. As shown in FIG. 2, the seat portion 22 extends in the X axis direction together with the track body 30. A first mounting portion 22a (step) is formed on a surface of the seat portion 22 directed to the negative Y side.

The column portion 23 is disposed on the negative Y side of the seat portion 22 and stands upward (positive Z side) from the bottom plate portion 21. The column portion 23 also extends in the X axis direction together with the seat portion 22 (first mounting portion 22a). The height of the top portion of the column portion 23 is the same as the height of the first mounting portion 22a. A support member 41 is laid between the column portion 23 and the first mounting portion 22a.

As shown in FIG. 3, the support member 41 is formed to have an L-shape when viewed in the X axis direction. The support member 41 supports the coil units 40. The coil units 40 face the magnet 12 in the Z axis direction. The coil units 40 include a coil group of a U-phase, a V-phase, and a W-phase in the X axis direction. For example, a plurality of coil units 40 (four units in the present embodiment) are provided side by side in the X axis direction.

As shown in FIG. 3, the drive board 50 is disposed on a lower side (negative Z side) of the coil units 40 and is fixed to the bottom plate portion 21 thereabove. The drive board 50 includes connectors 81 connected to the coil units 40 through cables (not shown), and motor drivers 82 for controlling movement of the mobile body 2 in the X axis direction by causing a current to flow to the coil units 40 through the cables. The drive board 50 is disposed in a manner of penetrating the seat portion 22 in the Y axis direction (which will be described below).

The cover 70 covers a part (base portion 51) protruding to the positive Y side beyond the seat portion 22 of the drive board 50. Various connectors connecting the drive board 50 and external devices (not shown) are provided in the cover 70. For example, the reference signs 71 and 72 shown in FIG. 2 indicate communication connectors. In addition, the reference sign 73 indicates a power connector. In addition, the reference sign 74 indicates a USB connector.

A second mounting portion 22b (step) is formed on a surface of the seat portion 22 directed to the positive Y side. The linear encoder 60 is mounted on the second mounting portion 22b. As shown in FIG. 3, the linear encoder 60 is formed to have an L-shape when viewed in the X axis direction. The linear encoder 60 includes a mounting base 61, a positioning plate 62, a sensor cover 63, and position detection sensors 64.

The mounting base 61 is formed to have a plate shape extending along the X-Y plane and is fixed to the second mounting portion 22b. The positioning plate 62 is mounted on an end portion of the mounting base 61 in the positive Y side using screw members 61a. The positioning plate 62 stands upward (positive Z side) from the end portion of the mounting base 61 in the positive Y side. The positioning plate 62 extends along an X-Z plane.

As shown in FIG. 2, the positioning plate 62 extends along the mobile body 2 in the moving direction (X axis direction) and faces the linear scale 13 in the Y axis direction. A protective film 62a is attached to a surface of the positioning plate 62 facing the linear scale 13. As shown in FIG. 3, a surface of the positioning plate 62 not facing the linear scale 13 is covered by the sensor cover 63. The position detection sensors 64 are disposed on the inward side of the sensor cover 63.

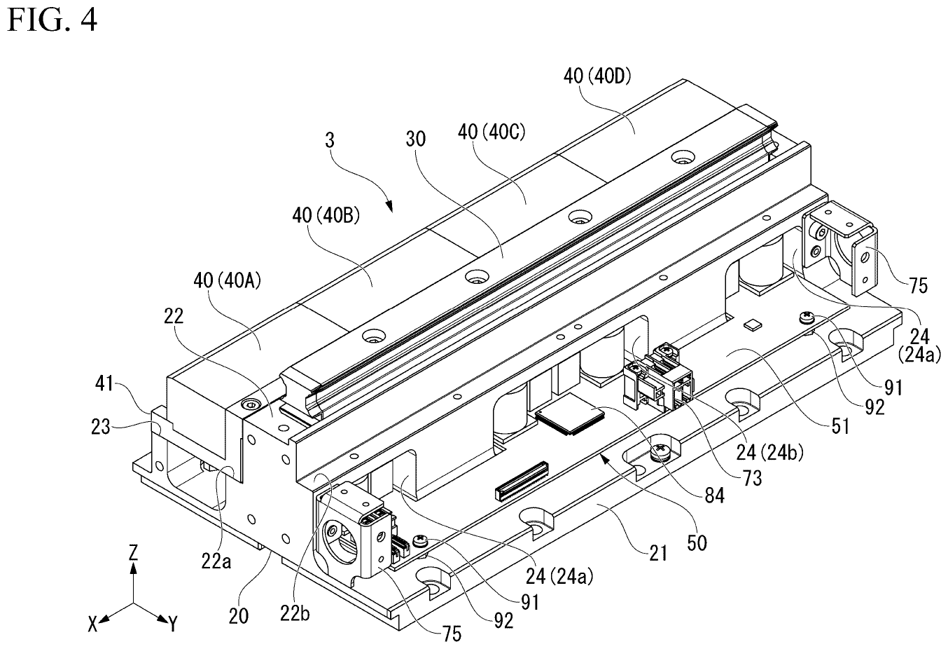

FIG. 4 is a perspective view of the linear motor module 3 according to the embodiment. In FIG. 4, for improved visibility, the mobile body 2 and the cover 70 are not shown. The reference sign 75 shown in FIG. 4 indicates a mounting frame for mounting the cover 70 in the base member 20.

As shown in FIG. 4, the linear motor module 3 includes four coil units 40A to 40D. The four coil units 40A to 40D are disposed side by side in the X axis direction.

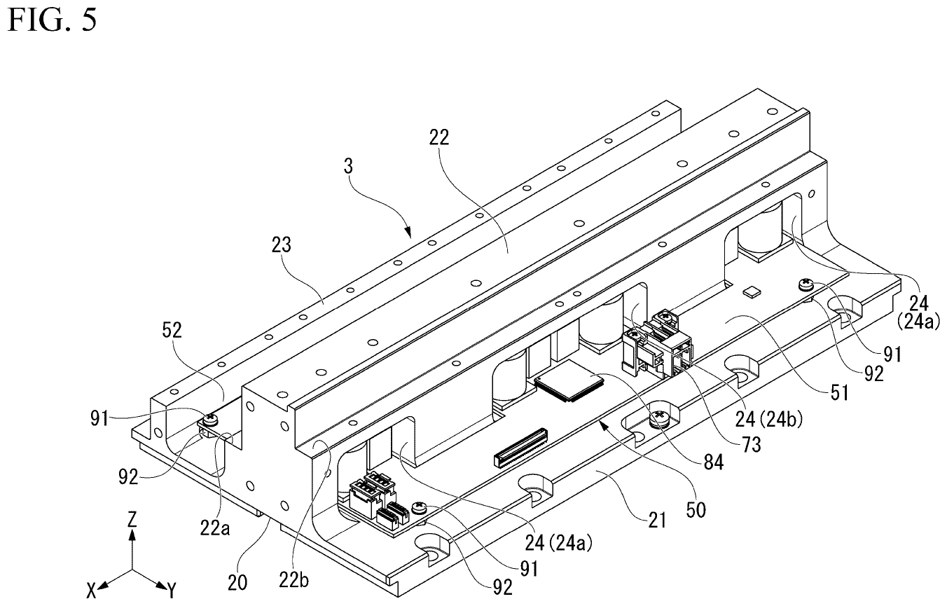

FIG. 5 is a perspective view of the base member 20 and the drive board 50 according to the embodiment. In FIG. 5, for further improved visibility than in FIG. 4, the coil units 40, the support member 41, and the mounting frame 75 are not shown.

As shown in FIG. 5, a plurality of space portions (hereinafter, through holes 24) are formed in a side portion of the seat portion 22 with an interval therebetween in the X axis direction. Each of the plurality of through holes 24 is positioned on the lower side (negative Z side) of the second mounting portion 22b and penetrates the seat portion 22 in the Y axis direction.

The drive board 50 is fixed to the bottom plate portion 21 at a plurality of positions using screw members 91 and spacers 92. The drive board 50 is fixed to the bottom plate portion 21 using the spacers 92 in a state of floating slightly upward (positive Z side).

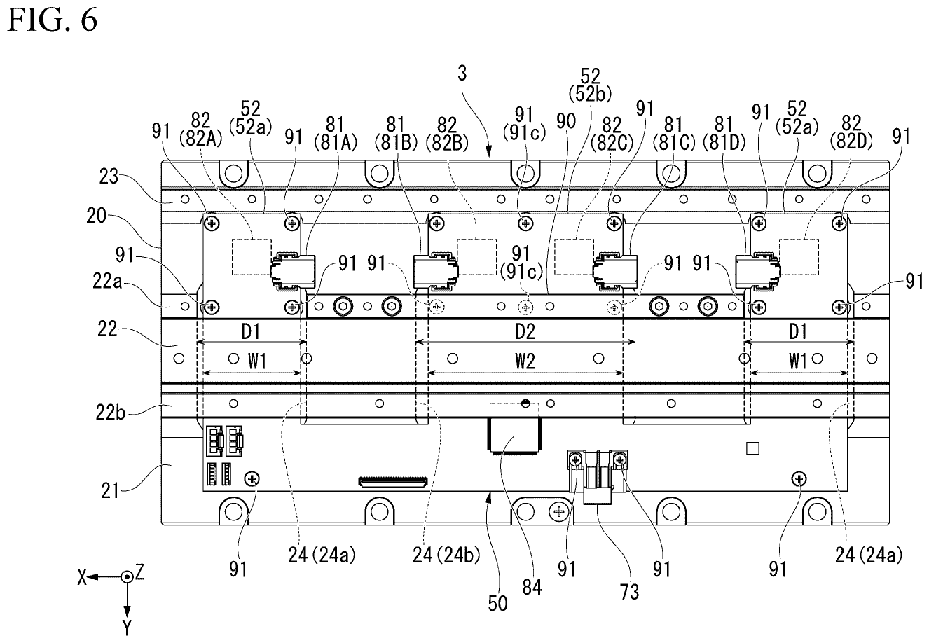

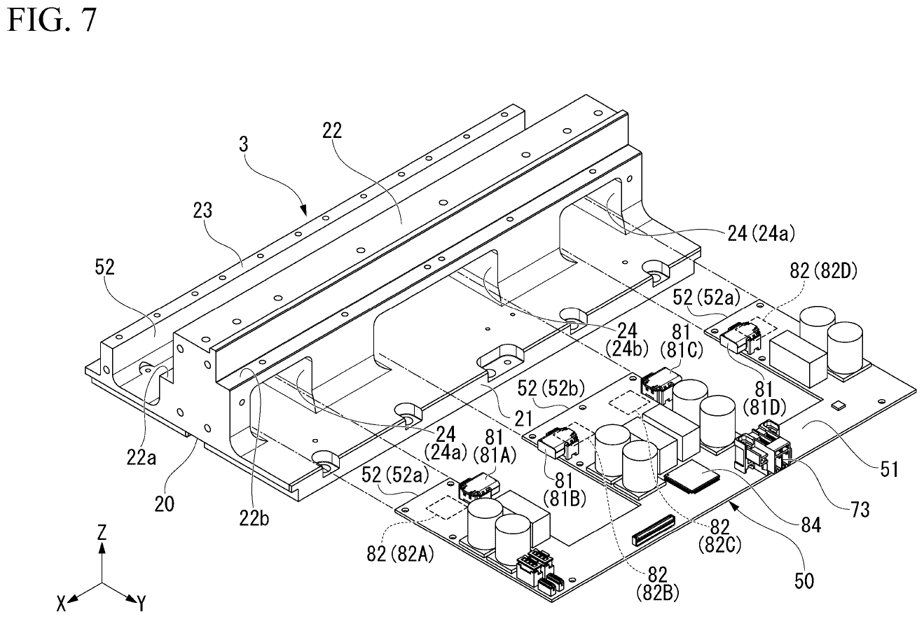

FIG. 6 is a plan view of the base member 20 and the drive board 50 shown in FIG. 5. FIG. 7 is a perspective view showing an assembly state of the base member 20 and the drive board 50 according to the embodiment.

As shown in FIGS. 6 and 7, a plurality of protruding portions (hereinafter, comb tooth portions 52) inserted into the plurality of through holes 24 are formed in the drive board 50.

The drive board 50 includes the base portion 51 extending in the X axis direction, and the plurality of comb tooth portions 52 extending toward the negative Y side from the base portion 51. The drive board 50 of the present embodiment includes three comb tooth portions 52 and is formed to have an E-shape in a plan view in the Z axis direction.

The motor drivers 82 for controlling the coil units 40 are provided in front end portions of the comb tooth portions 52. As shown in FIG. 3, the motor drivers 82 are disposed on surfaces of the comb tooth portions 52 directed to the negative Z side facing the bottom plate portion 21 and are in contact with the bottom plate portion 21 via a heat transfer member 83. Heat generated in the motor drivers 82 is transmitted to the base member 20 via the heat transfer member 83 and dissipates.

As shown in FIGS. 6 and 7, three through holes 24 described above are formed in the seat portion 22. The through holes 24 include through holes 24 with two kinds of sizes (first through holes 24a and a second through hole 24b). The first through holes 24a are formed in both end portions of the seat portion 22 in the X axis direction. The second through hole 24b is formed in a central portion of the seat portion 22 in the X axis direction.

As shown in FIG. 6, the first through holes 24a are formed with a first length D1 in the X axis direction. In addition, the second through hole 24b is formed with a second length D2 in the X axis direction. The second length D2 is longer than the first length D1. Specifically, the second length D2 has a dimension approximately twice that of the first length D1.

On the other hand, the three comb tooth portions 52 are formed in the drive board 50. The comb tooth portions 52 include comb tooth portions 52 with two kinds of sizes (first comb tooth portions 52a and a second comb tooth portion 52b). The first comb tooth portions 52a are formed in both end portions of the base portion 51 in the X axis direction. The second comb tooth portion 52b is formed in a central portion of the base portion 51 in the X axis direction.

As shown in FIG. 6, the first comb tooth portions 52a are formed with a first width W1 in the X axis direction. In addition, the second through hole 24b is formed with a second width W2 in the X axis direction. The second width W2 is larger than the first width W1. Specifically, the second width W2 has a dimension approximately twice that of the first width W1.

The first comb tooth portions 52a can be inserted into the first through holes 24a. In other words, the first width W1 has a dimension slightly smaller than the first length D1. In addition, the second comb tooth portion 52b can be inserted into the second through hole 24b and cannot be inserted into the first through holes 24a. In other words, the second width W2 has a dimension slightly smaller than the second length D2 and a dimension larger than the first length D1.

The second comb tooth portion 52b is provided with a greater number of motor drivers 82 than the first comb tooth portions 52a. Specifically, the first comb tooth portion 52a disposed on the positive X side is provided with a connector 81A connected to the coil unit 40A (see FIG. 4) via a cable (not shown), and a motor driver 82A for controlling the coil unit 40A via the cable. The screw members 91 (and the spacers 92) are disposed in four locations around the motor driver 82A, and the motor driver 82A receives an approximately uniform load, thereby being in contact with the bottom plate portion 21 via the heat transfer member 83.

In addition, the first comb tooth portion 52a disposed on the negative X side is provided with a connector 81D connected to the coil unit 40D via a cable (not shown), and a motor driver 82D for controlling the coil unit 40D via the cable. The screw members 91 (and the spacers 92) are disposed in four locations around the motor driver 82D, and the motor driver 82D receives an approximately uniform load, thereby being in contact with the bottom plate portion 21 via the heat transfer member 83.

On the other hand, the second comb tooth portion 52b is provided with a connector 81B connected the coil unit 40B via a cable (not shown), and a motor driver 82B for controlling the coil unit 40B via the cable. Moreover, the second comb tooth portion 52b is provided with a connector 81C connected to the coil unit 40C via a cable (not shown), and a motor driver 82C for controlling the coil unit 40C via the cable.

The screw members 91 (and the spacers 92) are disposed in four locations around the motor driver 82B and in four locations around the motor driver 82C, and the motor driver 82B and the motor driver 82C receive approximately uniform loads, thereby being in contact with the bottom plate portion 21 via the heat transfer member 83. The four screw members 91 disposed around the motor driver 82B and the four screw members 91 disposed around the motor driver 82C share the two screw members 91c disposed between the motor driver 82B and the motor driver 82C. That is, the motor driver 82B and the motor driver 82C are fixed using six screw members 91 in total.

A beam member 90 is mounted above the three screw members 91, of the six screw members 91c, disposed on an extension line of the first mounting portion 22a in a plan view shown in FIG. 6. The beam member 90 is mounted in an manner of being attachable and detachable with respect to the seat portion 22 via the screw members and forms a part of the first mounting portion 22a. The three screw members 91 disposed on the extension line of the first mounting portion 22a can be tightened or untightened by removing the beam member 90 from the seat portion 22.

The second comb tooth portion 52b is provided with at least a part of a control chip 84 for integrally controlling the motor drivers 82A to 82D. Since the second comb tooth portion 52b has a larger width in the X axis direction than the first comb tooth portions 52a, it is easy to lay out the control chip 84. In addition, the dimension of the base portion 51 in the Y axis direction can be made smaller than when the control chip 84 is laid out only on the base portion 51. In the present embodiment, the control chip 84 is laid out across the second comb tooth portion 52b and the base portion 51, but the control chip 84 may be laid out only on the second comb tooth portion 52b.

According to the foregoing constitution, as shown in FIG. 6, the drive board 50 can be disposed horizontally along the X-Y plane by forming the plurality of through holes 24 in the side portion of the seat portion 22 and inserting the comb tooth portions 52 of the drive board 50 into the through holes 24. For this reason, as shown in FIG. 3, the height dimension of the linear motor module 3 can be reduced. In addition, the comb tooth portions 52 penetrate the seat portion 22 in the Y axis direction, and therefore the drive board 50 can be disposed on both sides of the seat portion 22 in the Y axis direction. For this reason, the footprint of the linear motor module 3 can be made smaller than that when the drive board 50 is disposed on only one side of the seat portion 22 in the Y axis direction.

As described above, the linear motor module 3 of the present embodiment includes the track body 30 guiding the mobile body 2, the plurality of coil units 40 disposed along the track body 30, the drive board 50 electrically connected to the plurality of coil units 40, and the base member 20 supporting the track body 30, the plurality of coil units 40, and the drive board 50. The base member 20 is provided with the seat portion 22 for supporting the track body 30. The plurality of through holes 24 are formed in the side portion of the seat portion 22 with an interval therebetween in the length direction in which the track body 30 extends. The plurality of comb tooth portions 52 inserted into the plurality of through holes 24 are formed in the drive board 50. According to this constitution, it is possible to provide a linear motor module 3 having a small footprint and a small height dimension.

In addition, in the present embodiment, the comb tooth portions 52 are provided with the motor drivers 82 for controlling the coil units 40. According to this constitution, as shown in FIG. 3, the motor drivers 82 are disposed below the coil unit 40 so that the motor drivers 82 and the coil units 40 can be connected over a short distance.

In addition, in the present embodiment, the base member 20 is provided with the bottom plate portion 21 for supporting the seat portion 22, and the motor drivers 82 are disposed on surfaces of the comb tooth portions 52 facing the bottom plate portion 21 and are in contact with the bottom plate portion 21 via the heat transfer member 83. According to this constitution, heat generated in the motor drivers 82 can be transmitted to the bottom plate portion 21 via the heat transfer member 83 and dissipate efficiently.

In addition, in the present embodiment, as shown in FIG. 6, the plurality of through holes 24 include the first through holes 24a formed with the first length D1 in the length direction, and the second through hole 24b formed with the second length D2 longer than the first length D1 in the length direction. The plurality of comb tooth portions 52 include the first comb tooth portions 52a inserted into the first through holes 24a, and the second comb tooth portion 52b inserted into the second through hole 24b and having a larger width in the length direction than the first comb tooth portions 52a. The second comb tooth portion 52b is provided with more motor drivers 82 than the first comb tooth portions 52a, and is provided with the control chip 84 for controlling the motor drivers 82. According to this constitution, the second comb tooth portion 52b is provided with two motor drivers 82B and 82C so that it is easy to lay out the control chip 84. For instance, when four comb tooth portions 52 are formed corresponding to the four motor drivers 82, four through holes 24 are required to be formed in the seat portion 22 as well. If the number of through holes 24 of the seat portion 22 increases, the cost of processing the base member 20 increases, and it becomes difficult to ensure the rigidity of the seat portion 22 supporting the track body 30. Therefore, as in the present embodiment, it is preferable to provide the second comb tooth portion 52b having a wide width.

In addition, the linear conveyance system 1 of the present embodiment includes the foregoing linear motor module 3, and the mobile body 2 including the magnet 12 capable of facing the plurality of coil units 40 and guided along the track body 30. A plurality of linear motor modules 3 are joinable such that a plurality of track bodies 30 are connected in series. According to this constitution, it is possible to establish the linear conveyance system 1 having a small footprint and a small height dimension by joining the plurality of linear motor modules 3.

Hereinabove, a preferred embodiment of the present invention has been described with reference to the drawings, but the present invention is not limited to the embodiment described above. The shapes, the combinations, and the like of the constituent members shown in the embodiment described above are merely examples, and various modifications can be made based on design requirements and the like within a range not departing from the spirit of the present invention.

For example, through holes have been described as space portions, but the present invention is not limited to this. It is possible to achieve the same effect even if the protruding portions of the drive board are inserted into hole portions or groove portions which do not penetrate the seat portion.

### INDUSTRIAL APPLICABILITY

According to an aspect of the present invention, it is possible to reduce a footprint and reduce a height dimension.

### REFERENCE SIGNS LIST

1 Linear conveyance system
2 Mobile body
3 Linear motor module
12 Magnet
20 Base member
21 Bottom plate portion
22 Seat portion
24 Through hole (space portion)
24a First through hole
24b Second through hole
30 Track body
40 Coil unit
50 Drive board
52 Comb tooth portion (protruding portion)
52a First comb tooth portion
52b Second comb tooth portion
82 Motor driver
83 Heat transfer member
84 Control chip
D1 First length
D2 Second length
W1 First width
W2 Second width

1. A linear motor module comprising:
a track body guiding a mobile body;
a plurality of coil units disposed along the track body;
a drive board electrically connected to the plurality of coil units; and
a base member supporting the track body, the plurality of coil units, and the drive board,
wherein a seat portion for supporting the track body is provided in the base member,
a plurality of space portions are formed in a side portion of the seat portion with an interval therebetween in a length direction in which the track body extends, and
a plurality of protruding portions inserted into the plurality of space portions are formed in the drive board.

2. The linear motor module according to claim 1,
wherein a motor driver for controlling the coil unit is provided in the protruding portion.

3. The linear motor module according to claim 2,
wherein a bottom plate portion for supporting the seat portion is provided in the base member, and
the motor driver is disposed on a surface of the protruding portion facing the bottom plate portion and is in contact with the bottom plate portion via a heat transfer member.

4. The linear motor module according to claim 2,
wherein the plurality of space portions include
a first space portion formed to have a first length in the length direction, and
a second space portion formed to have a second length longer than the first length in the length direction,
the plurality of protruding portions include
a first protruding portion inserted into the first space portion, and
a second protruding portion inserted into the second space portion and having a larger width than the first protruding portion in the length direction, and
the second protruding portion is provided with a greater number of the motor drivers than the first protruding portion and is provided with at least a part of a control chip for controlling the motor drivers.

5. A linear conveyance system comprising:
the linear motor module according to claim 1; and
a mobile body including a magnet capable of facing the plurality of coil units and guided along the track body,
wherein a plurality of the linear motor modules are joinable such that a plurality of the track bodies are connected in series.
